(19) United States
(12) Patent Application Publication
(10) Pub. No.: US 2025/0055037 A1
(43) Pub. Date: Feb. 13, 2025

(54) BATTERY AND MODULE

(71) Applicant: TOYOTA JIDOSHA KABUSHIKI KAISHA, Toyota-shi Aichi-ken (JP)

(72) Inventors: Kota OHATA, Toyota-shi Aichi-ken (JP); Masahiro ISHIZUKA, Toyota-shi Aichi-ken (JP); Hajime HASEGAWA, Aichi-gun Aichi-ken (JP); Mitsuru TATEISHI, Toyota-shi Aichi-ken (JP); Norihiro OSE, Nagoya-shi Aichi-ken (JP); Masashi CHIHARA, Nagoya-shi Aichi-ken (JP)

(73) Assignee: TOYOTA JIDOSHA KABUSHIKI KAISHA, Toyota-shi Aichi-ken (JP)

(21) Appl. No.: 18/763,386

(22) Filed: Jul. 3, 2024

(30) Foreign Application Priority Data
Aug. 8, 2023 (JP) 2023-129610

(51) Int. Cl. H01M 10/0585; H01M 10/052; H01M 50/105; H01M 50/178; H01M 50/46; H01M 50/489; H01M 50/548

(52) U.S. Cl. CPC H01M 10/0585; H01M 10/052; H01M 50/105; H01M 50/178; H01M 50/46; H01M 50/489; H01M 50/548; H01M 2220/20

(57) ABSTRACT

A battery of the present disclosure has: an electrode body that is flat and is configured by a positive electrode and negative electrode layered alternately via a separator; an exterior body; a positive electrode tab projecting from the exterior body in a first direction that is orthogonal; and a negative electrode tab projecting from the exterior body in the first direction or in an opposite direction to the first direction. The exterior body has at least one laminate sheet. The electrode body has, at both edge portions in a second direction that is orthogonal to the thickness direction and to the first direction, non-contact portions at which the positive electrode and the negative electrode do not contact the separator. The exterior body has welded portions at which portions of the laminate sheet are welded together via at least portions of the non-contact portions.

### CROSS-REFERENCE TO RELATED APPLICATION

This application is based on and claims priority under 35 USC 119 from Japanese Patent Application No. 2023-129610 filed on Aug. 8, 2023, the disclosure of which is incorporated by reference herein.

### BACKGROUND

### Technical Field

The present disclosure relates to a battery and a module.

### Related Art

Lithium secondary batteries (hereinafter also called “batteries”) that use a non-aqueous electrolyte liquid are used in information communication technologies (e.g., personal computers, smartphones and the like), and in vehicles and for power storage and the like.

The battery has an electrode body in which positive electrodes and negative electrodes are layered alternately via separators. Electrode tabs are formed at the electrode body. At times of charging and discharging the battery, a large amount of heat is generated at the electrode tabs through which current passes. The separators are generally porous films made of resin. Therefore, of the separator, it is easy for the region thereof that is adjacent to an electrode tab to contract. If the separator contracts, there is the concern that the positive electrode and the negative electrode will contact one another, and short circuiting will occur.

U.S. Patent Application Publication No. 2018/0145376 discloses a battery assembly 900 in which contraction of the portion, which is adjacent to an electrode tab, of a separator can be suppressed. The battery assembly 900 is disposed within the battery case of a battery. As illustrated in FIG. 6 and FIG. 7, the battery assembly 900 has plural electrode plates 910 (positive electrodes or negative electrodes), separators 920, and insulation enhancing portions 930 for suppressing thermal contraction of the separators 920. The separators 920 are interposed between the plural electrode plates 910, respectively. An electrode tab 911 is formed at each of the plural electrode plates 910. The separators 920 have surplus outer peripheral portions that are larger than the outer peripheries of the electrode plates 910. The insulation enhancing portions 930 are formed at, of the surplus outer peripheral portions of the separators 920, the portions thereof that are adjacent to the electrode tabs 911. The insulation enhancing portions 930 have width W, and join the outer peripheries of the electrode plates 910 and the surplus outer peripheral portions of the separators 920.

However, U.S. Patent Application Publication No. 2018/0145376 does not include any disclosure relating to the relationship between the battery assembly 900 and the battery case. If the battery assembly 900 is merely housed in the battery case, at times of abnormal heat generation of the battery, there is the concern that both edge portions E920 (see FIG. 6) of the separators 920 will contract and short-circuiting will occur.

### SUMMARY

The present disclosure was made in view of the above-described circumstances. A topic addressed by embodiments of the present disclosure is the provision of a battery and a module at which the occurrence of short-circuiting is suppressed.

Techniques for addressing the above-described topic include the following embodying aspects.

<1> A battery of a first aspect of the present disclosure is a battery, including:
an electrode body that is flat and is configured by a positive electrode and negative electrode layered alternately via a separator;
an exterior body accommodating the electrode body;
a positive electrode tab that projects-out from the exterior body in a first direction that is orthogonal to a thickness direction of the electrode body, and that is electrically connected to the positive electrode; and
a negative electrode tab that projects out from the exterior body in the first direction or in an opposite direction to the first direction, and that is electrically connected to the negative electrode, wherein:
the exterior body has at least one laminate sheet,
the electrode body has, at both edge portions in a second direction that is orthogonal to the thickness direction and to the first direction, non-contact portions at which the positive electrode and the negative electrode do not contact the separator, and
the exterior body has welded portions at which portions of the laminate sheet are welded together via at least portions of the non-contact portions.

In the present disclosure, “laminate sheet” means a sheet having at least a metal layer, a first resin layer layered on one main surface of the metal layer, and a second resin layer layered on another main surface of the metal layer. In the present disclosure, in a case in which the exterior body has one laminate sheet, the “portions of the laminate sheet” mean a first portion and a second portion of the one laminate sheet. In a case in which the exterior body has plural laminate sheets, the “portions of the laminate sheet” mean a portion of a first laminate sheet and a portion of a second laminate sheet.

In the first aspect, the exterior body has the welded portions at which portions of the laminate sheet are welded together via at least portions of the non-contact portions. Namely, the portions (hereinafter called “both edge portions”), which correspond to the both edge portions of the electrode body in the second direction, of the separator are nipped between portions of the laminate sheet and are fixed to the welded portions. Therefore, at times of abnormal heat generation of the battery, it is more difficult for the both edge portions of the separator of the first aspect to contract than in a case in which the both edge portions of the separator are not nipped between portions of the laminate sheet. As a result, in the battery of the first aspect, the occurrence of short-circuiting is suppressed.

<2> A battery of a second aspect of the present disclosure is the battery of above <1>, wherein:
the positive electrode includes plural positive electrode sheets,
the negative electrode includes plural negative electrode sheets,
the separator includes plural separator sheets,
the electrode body is configured by the positive electrode sheets and the negative electrode sheets layered alternately via the separator sheets along the thickness direction, and
the non-contact portions extend along the first direction.

The battery of the second aspect is a so-called laminated battery.

<3> A battery of a third aspect of the present disclosure is the battery of above <1> or <2>, wherein
when viewing the exterior body from the thickness direction, a ratio (hereinafter also called “ratio (SR10A/SR20)”) of a surface area (hereinafter also called “SR10A”) of the non-contact portion that is within the welded portion, with respect to a surface area (hereinafter also called “SR20”) of the welded portion, is greater than or equal to 10%.

Due thereto, the both edge portions of the separator of the third aspect are fixed more strongly to the welded portions than in a case in which the ratio (SR10A/SR20) is less than 10%. Therefore, at times of abnormal heat generation of the battery, it is more difficult for the both edge portions of the separator of the third aspect to contract. As a result, in the battery of the third aspect, the occurrence of short-circuiting is suppressed even more.

<4> A battery of a fourth aspect of the present disclosure is the battery of any one of above <1> through <3>, wherein

surfaces of the separator at the non-contact portions (hereinafter also called “first portions”) that are within the welded portions are rougher than surfaces of the separator at a portion (hereinafter also called “second portion”) that is different from the non-contact portions that are within the welded portions.

In the present disclosure, the “surface is rough” means that the value of the surface roughness is great. An example of the surface roughness is the arithmetic mean roughness (Ra) measured in accordance with JIS B 0601:2013.

Due thereto, in the fourth aspect, the surface area of contact of the portions of the separator, which portions are at the first portions, with the welded portions is greater than in a case in which the surfaces of the portions of the separator, which portions are at the first portions, are not rougher than the surfaces of the separator at the second portion. Due thereto, the both edge portions of the separator of the fourth aspect are fixed more strongly to the welded portions. As a result, in the battery of the fourth aspect, the occurrence of short-circuiting is suppressed even more.

<5> A battery of a fifth aspect of the present disclosure is the battery of any one of above <1> through <4>, wherein

a thickness of the separator at the non-contact portions that are within the welded portions is thinner than a thickness of the separator at a portion that is different from the non-contact portions that are within the welded portions.

Due thereto, in the fifth aspect, the surface area of contact of the portions of the separator, which portions are at the first portions, with the welded portions is greater than in a case in which the thickness of the portions of the separator, which portions are at the first portions, is not thicker than the thickness of the separator at the second portion. Due thereto, the both edge portions of the separator of the fifth aspect are fixed more strongly to the welded portions. As a result, in the battery of the fifth aspect, the occurrence of short-circuiting is suppressed even more.

<6> A module of a sixth aspect of the present disclosure is a module, including:
plural batteries of any one of above <1> through <5>; and
a case that houses the plural batteries.

Due thereto, in the module of the sixth aspect, the occurrence of short-circuiting is suppressed.

In accordance with the present disclosure, there are provided a battery and a module in which the occurrence of short-circuiting is suppressed.

### BRIEF DESCRIPTION OF THE DRAWINGS

Exemplary embodiments of the present disclosure will be described in detail based on the following figures, wherein:

FIG. 1 is a front view of a battery relating to an embodiment of the present disclosure;

FIG. 2 is a cross-sectional view, along line II-II, of the battery of FIG. 1;

FIG. 3 is a perspective view of a module relating to an embodiment of the present disclosure;

FIG. 4 is a top view of a state in which a case cover of the module relating to the embodiment of the present disclosure has been removed;

FIG. 5 is a schematic drawing of a vehicle in which the module relating to the embodiment of the present disclosure is installed;

FIG. 6 is a front view of a battery assembly disposed within a battery case of a conventional battery; and

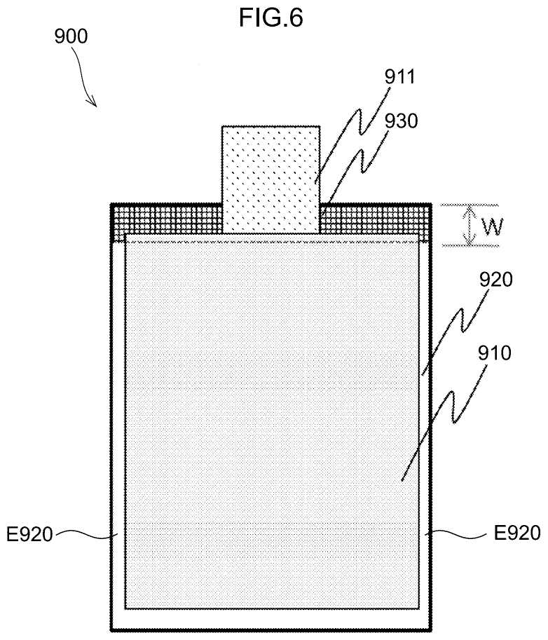

FIG. 7 is a side view of the battery assembly disposed within the battery case of the conventional battery.

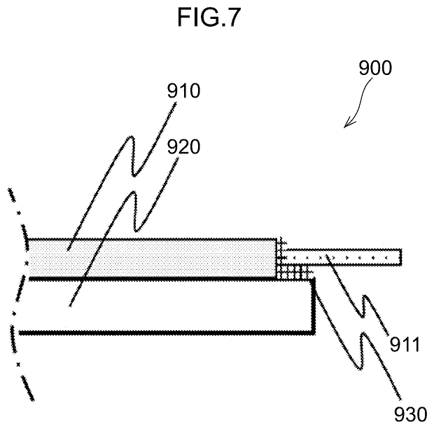

### DETAILED DESCRIPTION

Embodiments of the present disclosure are described hereinafter. The description thereof, and the Examples, exemplify embodied forms and do not limit the scope of the embodiments.

In the present disclosure, combinations of two or more aspects are more desirable aspects.

In the present disclosure, numerical ranges expressed by using “˜” mean ranges in which the numerical values listed before and after the “˜” are included as the minimum value and maximum value, respectively.

In numerical value ranges that are expressed in a stepwise manner in the present disclosure, the maximum value or the minimum value listed in a given numerical value range may be substituted by the maximum value or the minimum value of another numerical value range that is expressed in a stepwise manner. In the numerical value ranges put forth in the present disclosure, the maximum value or the minimum value of a numerical value range may be substituted by a value set forth in the Examples.

Embodiments of a battery of the present disclosure and a module of the present disclosure are described hereinafter with reference to the drawings. In the drawings, the same or corresponding portions are denoted by the same reference numerals, and description thereof is not repeated.

### (1) Battery

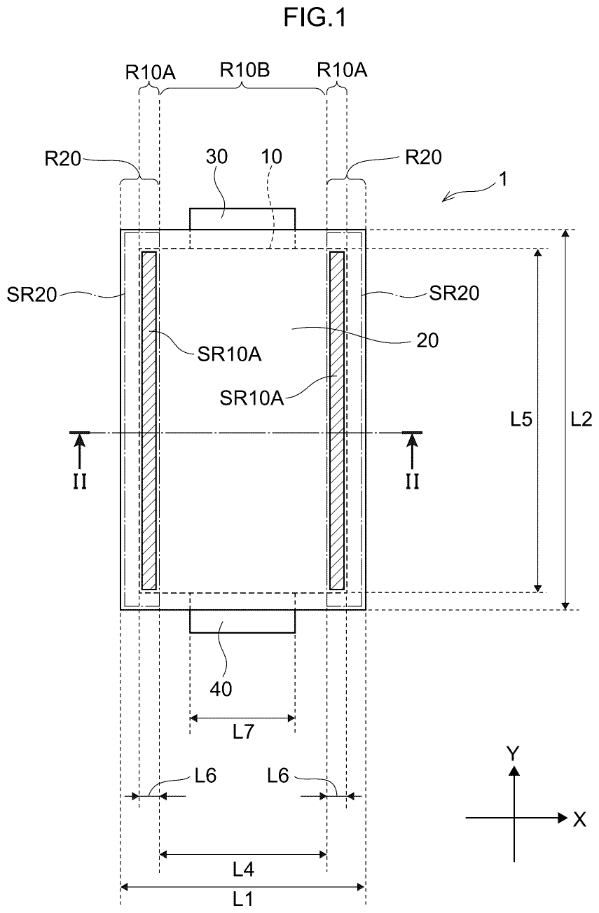

As illustrated in FIG. 1, a battery 1 relating to an embodiment of the present disclosure has an electrode body 10 that is flat, an exterior body 20, a positive electrode tab 30, a negative electrode tab 40, and a non-aqueous electrolyte liquid (not illustrated). The battery 1 is a rectangular parallelepiped shaped object.

In the present embodiment, one side in the short side direction of a main surface of the battery 1 is defined as the X-axis positive direction, and the opposite side is defined as the X-axis negative direction. The positive electrode tab 30 side in the long side direction of the main surface of the battery 1 is defined as the Y-axis positive direction, and the opposite side is defined as the Y-axis negative direction. One side in the thickness direction of the battery 1 is defined as the Z-axis positive direction, and the opposite side is defined as the Z-axis negative direction. The X-axis, the Y-axis and the Z-axis are orthogonal to one another. The Y-axis is an example of the first direction. The X-axis is an example of the second direction. The Z-axis is an example of the thickness direction of the electrode body. Note that these directions do not limit the directions at the time when the battery of the present disclosure is used.

The exterior body 20 houses the electrode body 10 and the non-aqueous electrolyte liquid. The exterior body 20 has two welded portions R20. The positive electrode tab 30 projects-out from the exterior body 20 in the Y-axis positive direction. The negative electrode tab 40 projects-out from the exterior body 20 in the Y-axis negative direction.

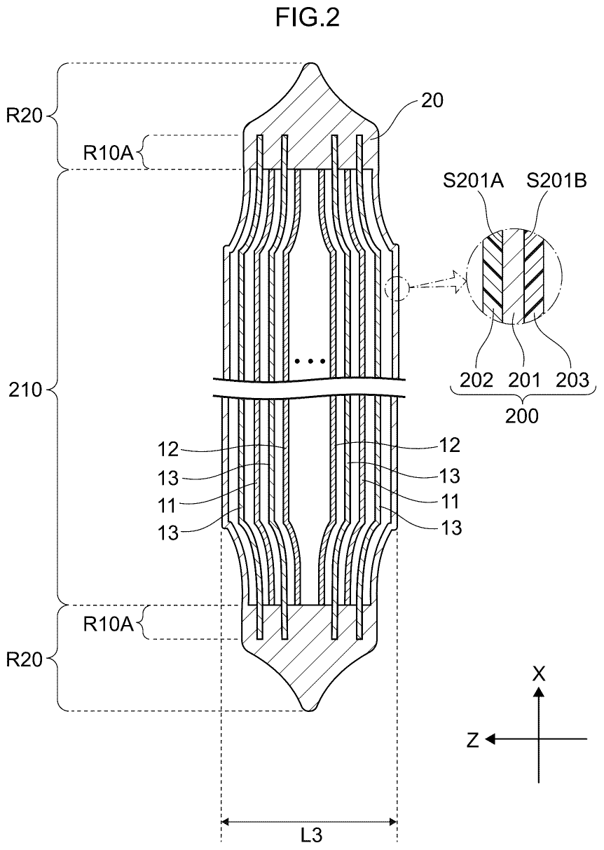

Length L1 (see FIG. 1) of the battery 1 in the X-axis direction is 80 mm˜110 mm for example. Length L2 (see FIG. 1) of the battery 1 in the Y-axis direction is 530 mm˜ 600 mm for example. Length L3 (see FIG. 2) of the battery 1 in the Z-axis direction is 7.0 mm˜ 9.0 mm for example.

### (1.1) Electrode Body

The structure of the electrode body 10 is a laminated structure. As illustrated in FIG. 2, the electrode body 10 includes plural positive electrode sheets 11, plural negative electrode sheets 12, and plural separator sheets 13. At the electrode body 10, the positive electrode sheets 11 and the negative electrode sheets 12 are layered alternately via the separator sheets 13. The positive electrode sheet 11 is an example of the positive electrode. The negative electrode sheet 12 is an example of the negative electrode. The separator sheet 13 is an example of the separator.

The numbers of the positive electrode sheets 11, the negative electrode sheets 12 and the separator sheets 13 respectively are not particularly limited, and are selected appropriately in accordance with the application of the battery 1 or the like.

As illustrated in FIG. 1, the electrode body 10 has a pair of non-contact portions R10A and an electrode portion R10B. The pair of non-contact portions R10A are positioned at the X-axis direction both end portions of the electrode body 10. The electrode portion R10B is positioned between the pair of non-contact portions R10A in the X-axis direction.

The electrode portion R10B is the portion that generates electricity. At the electrode portion R10B, the positive electrode sheets 11 and the negative electrode sheets 12 are layered alternately via the separator sheets 13. In the present embodiment, the outermost layers of the electrode portion R10B are structured by the separator sheets 13. Length L4 (see FIG. 1) of the electrode portion R10B in the X-axis direction is 60 mm˜ 105 mm for example. Length L5 (see FIG. 1) of the electrode portion R10B in the Y-axis direction is 500 mm˜ 520 mm for example.

The non-contact portions R10A are portions that do not generate electricity. The non-contact portions R10A are portions of the electrode body 10 at which the positive electrode sheets 11 and the negative electrode sheets 12 do not contact the separator sheets 13. Namely, the non-contact portions R10A are formed only by the plural separator sheets 13. The non-contact portions R10A extend along the Y-axis direction. Length L6 (see FIG. 1) of the non-contact portion R10A in the X-axis direction is 1 mm˜ 20 mm for example. The length of the non-contact portion R10A in the Y-axis direction is the same as the length L5 (see FIG. 1) of the electrode portion R10B in the Y-axis direction.

### (1.1.1) Positive Electrode Sheet

The positive electrode sheet 11 has a positive electrode collector (e.g., an aluminum foil or the like), and a positive electrode active material layer supported by the positive electrode collector. The positive electrode active material layer contains a positive electrode active material. The positive electrode active material releases lithium ions into the non-aqueous electrolyte liquid or takes lithium ions from the non-aqueous electrolyte liquid. It suffices for the positive electrode active material to be a known positive electrode active material (e.g., LiNiO₂, LiNi_{1/3}Co_{1/3}Mn_{1/3}O₂ or the like). The positive electrode active material layer may further contain a known conduction material (e.g., carbon black or the like), trilithium phosphate, and a known binder (e.g., polyvinylidene fluoride or the like).

### (1.1.2) Negative Electrode Sheet

The negative electrode sheet 12 has a negative electrode collector (e.g., a copper foil or the like), and a negative electrode active material layer supported by the negative electrode collector. The negative electrode active material layer contains a negative electrode active material. Accompanying charging/discharging, the negative electrode active material takes lithium ions, which are a charge carrier, from the non-aqueous electrolyte liquid and releases lithium ions into the non-aqueous electrolyte liquid. It suffices for the negative electrode active material to be a known negative electrode active material (artificial graphite, a lithium alloy (e.g., LiXM, where M is C, Si, Sn, Sb, Al, Mg, Ti, Bi, Ge, Pb, P or the like, and X is a natural number), or the like). The negative electrode active material layer may further contain a known binder (e.g., a styrene-butadiene copolymer or the like).

### (1.1.3) Separator Sheet

The separator sheet 13 electrically insulates the positive electrode and the negative electrode, and provides paths for movement of lithium ions between the positive electrode active material layer and the negative electrode active material layer. A porous film and the like are examples of the separator sheet 13. Examples of the material of the porous film are polyethylene, polypropylene and the like. The separator sheet 13 may be a single-layer structure, or may be a multilayer structure.

The surfaces of the separator sheets 13 at the non-contact portions R10A within the welded portions R20 are rougher than the surfaces of the separator sheets 13 at the portion (i.e., the electrode portion R10B) that is different from the non-contact portions R10A within the welded portions R20. The welded portions R20 are usually formed by hot pressing. At the time of carrying out the hot pressing, creeping arises at the portions of the separator sheets 13 that are at the non-contact portions R10A. “Creeping” is a phenomenon in which, at the time when an external force acts on an object, strain increases over time with respect to a constant stress. Namely, the surfaces of the separator sheets 13 at the non-contact portions R10A are stretched more than the surfaces before the hot pressing is carried out (i.e., surfaces that are equivalent to the surfaces at the electrode portion R10B). Therefore, the surfaces of the separator sheets 13 at the non-contact portions R10A within the welded portions R20 are rougher than the surfaces of the separator sheets 13 at the electrode portion R10B.

The thickness of the separator sheets 13 at the non-contact portions R10A within the welded portions R20 is thinner than the thickness of the separator sheets 13 at the portion (i.e., the electrode portion R10B) that is different from the non-contact portions R10A within the welded portions R20. The welded portions R20 are usually formed by hot pressing. Therefore, the thickness of the separator sheets 13 at the non-contact portions R10A within the welded portions R20 is thinner than the thickness of the separator sheets 13 at the electrode portion R10B.

### (1.2) Exterior Body

The exterior body 20 covers the electrode body 10 and, together with the positive electrode tab 30 and the negative electrode tab 40, seals the electrode body 10 and the non-aqueous electrolyte liquid.

In the present embodiment, the exterior body 20 has one laminate sheet 200. The one laminate sheet 200 has two embossed portions 210 (see FIG. 2) for accommodating the electrode body 10. The exterior body 20 is obtained by the one laminate sheet 200 being folded-over and sealed with the electrode body 10 nipped between the two embossed portions 210.

The exterior body 20 has the two welded portions R20. In the present embodiment, portions of the laminate sheet 200 are welded together at the welded portions R20 via the entire non-contact portions R10A.

In the present embodiment when the exterior body 20 is viewed from the Z-axis direction, the ratio (hereinafter also called “ratio (SR10A/SR20)”) of surface area SR10A (see FIG. 1) of the non-contact portion R10A within the welded portion R20, with respect to surface area SR20 (see FIG. 1) of the welded portion R20, is greater than or equal to 10%.

### (1.2.1) Laminate Sheet

As illustrated in FIG. 2, the laminate sheet 200 has a metal layer 201, an inner side resin layer 202, and an outer side resin layer 203. The inner side resin layer 202 is layered on surface S201A, which is at the electrode body 10 side, of the metal layer 201. The outer side resin layer 203 is layered on surface S201B, which is at the side opposite the electrode body 10 side, of the metal layer 201.

The metal layer 201 blocks entry and exit of gasses (e.g., humidity, air and the like) between the exterior of the battery 1 and the interior of the battery 1. Examples of the material of the metal layer 201 are metals (e.g., aluminum and the like).

The inner side resin layer 202 structures the welded portions R20. In addition, the inner side resin layer 202 electrically insulates the electrode body 10, the positive electrode tab 30 and the negative electrode tab 40 from the metal layer 201. The inner side resin layer 202 may contain a thermoplastic resin. Examples of the thermoplastic resin are olefin resins (e.g., polypropylene, polyethylene, and the like), polyvinyl chloride, polyvinylidene chloride, polystyrene resins, acrylonitrile-styrene copolymer (AS) resin, acrylonitrile-butadiene-styrene copolymer (ABS) resin, polyester resins, poly(meth)acrylic resins, polyvinyl alcohol, polycarbonate resins, polyamide resins, polyimide resins, polyether resins, polyacetal resins, fluorine resins, polysulfone resins, polyphenylene sulfide resins, polyketone resins and the like.

In some embodiments, the thermoplastic resin may include a resin that is compatible with the separator sheets 13. The adhesion of the welded portions R20 and the separator sheets 13 thereby improves. “Being compatible” means, in an atmosphere in which a first resin and a second resin melt, the first resin and the second resin mix together without separating. The resin that is compatible with the separator sheets 13 is appropriately selected in accordance with the material of the separator sheets 13. In some embodiments, in a case in which the separator sheets 13 contain polyethylene, the inner side resin layer 202 may contain polyethylene. In some embodiments, in a case in which the separator sheets 13 contain polypropylene, the inner side resin layer 202 may contain polypropylene.

The inner side resin layer 202 may contain a compounding agent as needed. Examples of the compounding agent are heat stabilizers, oxidation inhibitors, pigments, weatherproofing agents, flame retardants, plasticizers, dispersants, lubricants, mold releasing agents, antistatic agents, and the like.

The outer side resin layer 203 improves the durability of the laminate sheet 200. The outer side resin layer 203 may contain a thermoplastic resin. The thermoplastic resin of the outer side resin layer 203 is not particularly limited, and examples thereof are resins that are the same as those exemplified as the thermoplastic resin of the inner side resin layer 202. The thermoplastic resin of the outer side resin layer 203 may be the same as or may be different from the thermoplastic resin of the inner side resin layer 202. The outer side resin layer 203 may contain a compounding agent as needed. Examples of the compounding agent are heat stabilizers, oxidation inhibitors, pigments, weatherproofing agents, flame retardants, plasticizers, dispersants, lubricants, mold releasing agents, antistatic agents, and the like.

### (1.3) Positive Electrode Tab

The positive electrode tab 30 is electrically connected to the plural positive electrode sheets 11.

The positive electrode collectors have positive electrode lead regions that extend in the Y-axis positive direction. The positive electrode active material layers are not formed at the positive electrode lead regions. The positive electrode tab 30 may be formed from only the plural positive electrode lead regions. The positive electrode tab 30 may include the plural positive electrode lead regions, and positive electrode leads connected to the plural positive electrode lead regions. Length L7 (see FIG. 1) of the positive electrode tab 30 in the X-axis direction is 40 mm˜ 50 mm for example.

### (1.4) Negative Electrode Tab

The negative electrode tab 40 is electrically connected to the plural negative electrode sheets 12.

The negative electrode collectors have negative electrode lead regions that extend in the Y-axis negative direction. The negative electrode active material layers are not formed at the negative electrode lead regions. The negative electrode tab 40 may be formed from only the plural negative electrode lead regions. The negative electrode tab 40 may include the plural negative electrode lead regions, and negative electrode leads connected to the plural negative electrode lead regions. The length L7 (see FIG. 1) of the negative electrode tab 40 in the X-axis direction is 40 mm˜ 50 mm for example.

### (1.5) Non-Aqueous Electrolyte Liquid

The battery 1 has a non-aqueous electrolyte liquid. The non-aqueous electrolyte liquid is accommodated in the exterior body 20 together with the electrode body 10. It suffices for the non-aqueous electrolyte liquid to be a liquid in which a supporting salt (e.g., LiPF₆ or the like) that serves as the electrolyte is dissolved or dispersed in a non-aqueous solvent (e.g., ethyl carbonate or the like). The non-aqueous electrolyte may contain various types of additives (e.g., lithium bis(oxalato)borate and the like) or the like.

### (1.6) Application

The application of the battery 1 is not particularly limited, and examples thereof are use as the power source of a vehicle, the power source of an information processing device (e.g., a personal computer, a smartphone, or the like), the power source of a power storage unit, or the like.

### (1.7) Operation and Effects

As explained with reference to FIG. 1 and FIG. 2, the battery 1 has the electrode body 10, the exterior body 20, the positive electrode tab 30 and the negative electrode tab 40. The exterior body 20 has the one laminate sheet 200. The electrode body 10 has the non-contact portions R10A at the X-axis direction both edge portions thereof. The exterior body 20 has the welded portions R20 via the non-contact portions R10A.

Namely, the portions (hereinafter also called the “both edge portions”), which correspond to the X-axis both edge portions of the electrode body 10, of the separator sheets 13 are nipped between portions of the laminate sheet 200, and are fixed to the welded portions R20. Therefore, at times of abnormal heat generation of the battery 1, it is more difficult for the both edge portions of the separator sheets 13 to contract than in a case in which the both edge portions of the separator sheets 13 are not nipped between the portions of the laminate sheet 200. As a result, at the battery 1, the occurrence of short-circuiting is suppressed.

As described with reference to FIG. 1 and FIG. 2, at the battery 1, the electrode body 10 includes the plural positive electrode sheets 11, the plural negative electrode sheets 12, and the plural separator sheets 13. At the electrode body 10, the positive electrode sheets 11 and the negative electrode sheets 12 are layered alternately via the separator sheets 13 along the Z-axis direction. The non-contact portions R10A extend along the Y-axis direction. Namely, the battery 1 is a so-called laminated battery.

As described with reference to FIG. 1 and FIG. 2, at the battery 1, when the exterior body 20 is viewed from the Z-axis direction, ratio (SR10A/SR20) is greater than or equal to 10%.

Due thereto, the X-axis direction both edge portions of the separator sheets 13 are fixed in the welded portions R20 more strongly than in a case in which the ratio (SR10A/SR20) is less than 10%. Therefore, at times of abnormal heat generation of the battery, it is more difficult for the X-axis direction both edge portions of the separator sheets 13 to contract. As a result, at the battery 1, the occurrence of short-circuiting is suppressed more.

As described with reference to FIG. 1 and FIG. 2, at the battery 1, the surfaces of the separator sheets 13 at the non-contact portions R10A that are within the welded portions R20 are rougher than the surfaces of the separator sheets 13 at the portion (i.e., the electrode portion R10B) that is different from the non-contact portions R10A within the welded portions R20.

Due thereto, the surface area of contact of the portions of the separator sheets 13, which portions are at the non-contact portions R10A, with the welded portions R20 is greater than in a case in which the surfaces of the separator sheets 13 at the non-contact portions R10A are not rougher than the surfaces at the electrode portion R10B. Due thereto, the both edge portions of the separator sheets 13 are fixed to the welded portions R20 more strongly. As a result, at the battery 1, the occurrence of short-circuiting is suppressed more.

As described with reference to FIG. 1 and FIG. 2, at the battery 1, the thickness of the separator sheets 13 at the non-contact portions R10A that are within the welded portions R20 is thinner than the thickness of the separator sheets 13 at the portion (i.e., the electrode portion R10B) that is different from the non-contact portions R10A within the welded portions R20. Due thereto, the surface area of contact of the portions of the separator sheets 13, which portions are at the non-contact portions R10A, with the welded portions R20 is greater than in a case in which the thickness of the separator sheets 13 at the non-contact portions R10A is not thinner than the thickness of the separator sheets 13 at the electrode portion R10B. Due thereto, the both edge portions of the separator sheets 13 are fixed to the welded portions R20 more strongly. As a result, at the battery 1, the occurrence of short-circuiting is suppressed more.

### (2) Module

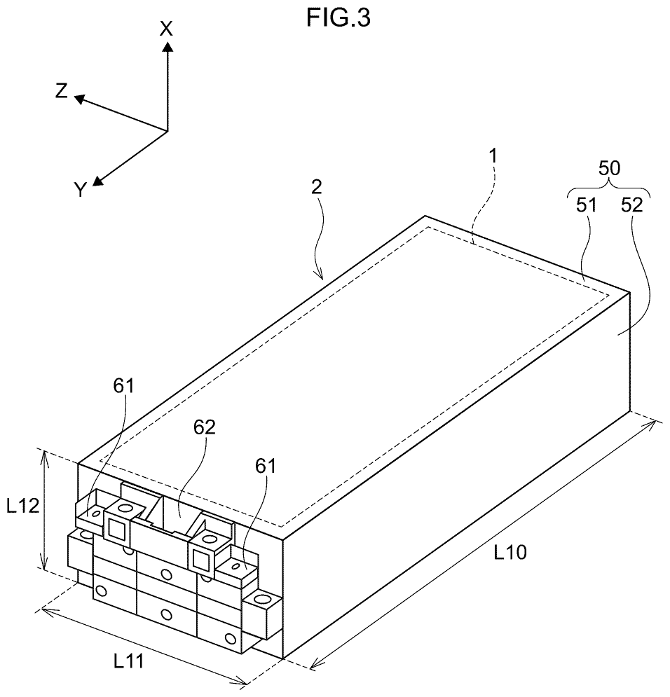

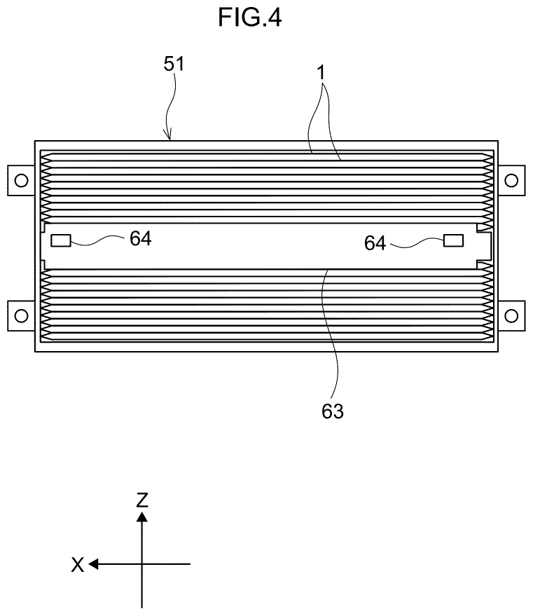

As illustrated in FIG. 3 and FIG. 4, a module 2 relating to an embodiment of the present disclosure has the plural batteries 1 and a case 50. The case 50 houses the plural batteries 1.

As illustrated in FIG. 3, the module 2 is a rectangular parallelepiped shaped object. Length L10 of the module 2 in the Y-axis direction is 350 mm˜ 600 mm for example. Length L11 of the module 2 in the Z-axis direction is 150 mm˜ 250 mm for example. Length L12 of the module 2 in the X-axis direction is 80 mm˜ 110 mm for example.

A pair of voltage terminals 61 and a connector 62 are provided at each of the Y-axis direction both end portions of the module 2. A flexible printed circuit board 63 that is described later is connected to the connectors 62. Unillustrated bus bars are welded to the Y-axis direction both end portions of the module 2.

The case 50 has a case main body 51 and a case cover 52. The case 50 is formed of an aluminum alloy. For example, the case 50 is formed by aluminum die cast members being joined by laser welding or the like to the both end portions of an extruded member that is an aluminum alloy.

As illustrated in FIG. 4, the plural batteries 1 are housed in a state of being lined-up at the interior of the module 2. In the present embodiment, 24 of the batteries 1 are lined-up along the Z-axis direction. The batteries 1 that are adjacent to one another are adhered together.

The flexible printed circuit (FPC) board 63 is disposed on the batteries 1. The flexible printed circuit board 63 is formed in the shape of a strip whose length direction is the X-axis direction. A thermistor 64 is provided at each of the both end portions of the flexible printed circuit board 63. At the module 2, the thermistors 64 are pushed toward the side of the batteries 1 by the case cover 52, without being adhered to the batteries 1.

One or plural unillustrated buffering members are accommodated within the module 2. For example, the buffering members are elastically-deformable, thin-plate-shaped members, and are disposed between the batteries 1 that are adjacent to one another such that the thickness directions of the buffering members are the direction in which the batteries 1 are lined-up. In the present embodiment, as an example, buffering members are disposed at the length direction both end portions and the length direction central portion of the module 2, respectively.

### (2.2) Usage Example

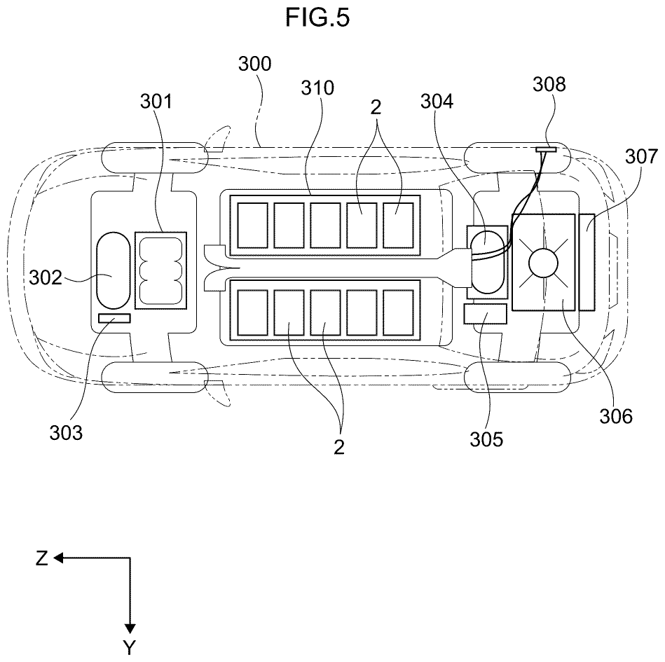

The module 2 is suitably used as a battery pack 310 that is the power source for a vehicle 300. As illustrated in FIG. 5, the vehicle 300 is an electric vehicle (BEV: Battery Electric Vehicle) in which the battery pack 310 is installed beneath the floor.

In the present embodiment, the X-axis positive direction, the Z-axis positive direction and the Y-axis positive direction respectively indicate the upper side in the vehicle vertical direction, the front side in the vehicle longitudinal direction and the left side in the vehicle transverse direction.

As an example, a DC/DC converter 301, an electrically-powered compressor 302, and a PTC (Positive Temperature Coefficient) heater 303 are disposed at the vehicle 300 of the present embodiment, at further toward the vehicle front side than the battery pack 310. Further, a motor 304, a gear box 305, an inverter 306 and a charger 307 are disposed further toward the vehicle rear side than the battery pack 310.

The voltage of the DC current, which is outputted from the battery pack 310, is adjusted by the DC/DC converter 301, and thereafter, the DC current is supplied to the electrically-powered compressor 302, the PTC heater 303, the inverter 306 and the like. Further, the rear wheels rotate and the vehicle 300 is made to travel due to electric power being supplied to the motor 304 via the inverter 306.

A charging port 308 is provided at the right side portion of the rear portion of the vehicle 300. By connecting a charging plug of an unillustrated, external charging equipment from the charging port 308, electric power can be stored in the battery pack 310 via the charger 307.

Note that the arrangement, the structure and the like of the respective parts that structure the vehicle 300 are not limited to the above-described structures. For example, the technique of the present disclosure may be applied to a hybrid vehicle (HV) or a plug-in hybrid electric vehicle (PHEV) that is equipped with an engine. In the present embodiment, the vehicle 300 is a rear wheel drive vehicle in which the motor 304 is installed in the vehicle rear portion. However, the present disclosure is not limited to this, and the vehicle may be a front wheel drive vehicle in which the motor 304 is installed in the vehicle front portion. Or, a pair of the motors 304 may be installed in the front and the rear of the vehicle. Moreover, the vehicle may be a vehicle in which in-wheel motors are provided at the respective wheels.

The battery pack 310 includes the plural modules 2. In the present embodiment, 10 of the modules 2 are provided. Specifically, five of the modules 2 are lined-up in the vehicle longitudinal direction at the right side of the vehicle 300, and five of the modules 2 are lined-up in the vehicle longitudinal direction at the left side of the vehicle 300. The plural modules 2 are electrically connected to one another.

### (2.3) Operation and Effects

As described with reference to FIG. 1 through FIG. 4, the module 2 has the plural batteries 1 and the case 50.

Due thereto, the occurrence of short-circuiting is suppressed at the module 2.

### (3) Modified Examples

In the present embodiment, the electrode body 10 is a laminated structure. However, the present disclosure is not limited to this, and the structure of the electrode body of the present disclosure may be a coiled type.

Although the ratio (SR10A/SR20) is greater than or equal to 10% in the present embodiment, the present disclosure is not limited to this. The ratio (SR10A/SR20) of the present disclosure may be less than 10%.

In the present embodiment, the surfaces of the separator sheets 13 at the non-contact portions 10A within the welded portions R20 are rougher than the surfaces of the separator sheets 13 at the electrode portion R10B, but the present disclosure is not limited to this. In the present disclosure, the surfaces of the separator sheets 13 at the non-contact portions 10A within the welded portions R20 do not have to be rougher than the surfaces of the separator sheets 13 at the electrode portion R10B.

In the present embodiment, the thickness of the separator sheets 13 at the non-contact portions R10A within the welded portions R20 is thinner than the thickness of the separator sheets 13 at the electrode portion R10B, but the present disclosure is not limited to this. In the present disclosure, the thickness of the separator sheets 13 at the non-contact portions R10A within the welded portions R20 does not have to be thinner than the thickness of the separator sheets 13 at the electrode portion R10B.

Although the exterior body 20 is structured by the one laminate sheet 200 in the present embodiment, the present disclosure is not limited to this, and the exterior body 20 may be structured by plural laminate sheets 200.

In the present embodiment, at the welded portions R20, portions of the laminate sheet 200 are welded together via the entire non-contact portions R10A. However, the present disclosure is not limited to this. At the welded portions R20, portions of the laminate sheet 200 may be welded together via portions of the non-contact portions R10A.

Although the exterior body 20 is a double cup embossed structure in the present embodiment, the present disclosure is not limited to this, and the exterior body 20 may be a single cup embossed structure.

What is claimed is:

1. A battery, comprising:
an electrode body that is flat and is configured by a positive electrode and negative electrode layered alternately via a separator;
an exterior body accommodating the electrode body;
a positive electrode tab that projects out from the exterior body in a first direction that is orthogonal to a thickness direction of the electrode body, and that is electrically connected to the positive electrode; and
a negative electrode tab that projects out from the exterior body in the first direction or in an opposite direction to the first direction, and that is electrically connected to the negative electrode, wherein:
the exterior body has at least one laminate sheet,
the electrode body has, at both edge portions in a second direction that is orthogonal to the thickness direction and to the first direction, non-contact portions at which the positive electrode and the negative electrode do not contact the separator, and
the exterior body has welded portions at which portions of the laminate sheet are welded together via at least portions of the non-contact portions.

2. The battery of claim 1, wherein:
the positive electrode includes a plurality of positive electrode sheets,
the negative electrode includes a plurality of negative electrode sheets,
the separator includes a plurality of separator sheets,
the electrode body is configured by the positive electrode sheets and the negative electrode sheets layered alternately via the separator sheets along the thickness direction, and
the non-contact portions extend along the first direction.

3. The battery of claim 1, wherein, when viewing the exterior body from the thickness direction, a ratio of a surface area of the non-contact portion that is within the welded portion, with respect to a surface area of the welded portion, is greater than or equal to 10%.

4. The battery of claim 1, wherein surfaces of the separator at the non-contact portions that are within the welded portions are rougher than surfaces of the separator at a portion that is different from the non-contact portions that are within the welded portions.

5. The battery of claim 1, wherein a thickness of the separator at the non-contact portions that are within the welded portions is thinner than a thickness of the separator at a portion that is different from the non-contact portions that are within the welded portions.

6. A module, comprising:
a plurality of the batteries of claim 1; and
a case that houses the plurality of batteries.
